(19) United States
(12) Patent Application Publication
(10) Pub. No.: US 2017/0194680 A1
(43) Pub. Date: Jul. 6, 2017

(54) Power Supply Module for a Voltage Supply Apparatus Arranged in a Vehicle

(71) Applicant: Bayerische Motoren Werke Aktiengesellschaft, Muenchen (DE)

(72) Inventors: Alexander MUCK, Muenchen (DE); Thomas HOEFLER, Groebenzell (DE); Tuncay IDIKURT, Muenchen (DE); Michael HUBER, Muenchen (DE); Daniel WAGNER, Muenchen (DE)

(21) Appl. No.: 15/455,396

(22) Filed: Mar. 10, 2017

Related U.S. Application Data
(63) Continuation of application No. PCT/EP2015/062324, filed on Jun. 3, 2015.

(30) Foreign Application Priority Data
Sep. 12, 2014 (DE) 10 2014 218 330.8

(51) Int. Cl. H01M 10/6556; H01M 10/63; H01M 10/625; H01M 10/647; H01M 2/10; H01M 10/04

(52) U.S. Cl. CPC H01M 10/6556; H01M 2/1077; H01M 10/0481; H01M 10/625; H01M 10/647; H01M 10/63; H01M 2220/20

(57) ABSTRACT

A power supply module for a voltage supply apparatus arranged in a vehicle is built from a plurality of structurally independently designed power supply cells. The power supply cells are stacked in at least one row of cells arranged one behind the other. The power supply module interacts with a temperature control device, wherein the temperature control device controls the temperature of at least one part of the power supply cells by a heating medium. A clamping device is designed to clamp the power supply cells of the at least one row of cells. The clamping device has at least two end plates and a tension element. The two end plates interact with the tension element to form a tensioning force acting on the power supply cells. The tension element is designed as a functional component of the temperature control device and has a feed connection for feeding the heating medium into the tension element and a discharge connection for discharging the heating medium passed through the partial region.

### CROSS REFERENCE TO RELATED APPLICATIONS

This application is a continuation of PCT International Application No. PCT/EP2015/062324, filed Jun. 3, 2015, which claims priority under 35 U.S.C. §119 from German Patent Application No. 10 2014 218 330.8, filed Sep. 12, 2014, the entire disclosures of which are herein expressly incorporated by reference.

### BACKGROUND AND SUMMARY OF THE INVENTION

The invention relates to a power supply module constructed from a plurality of structurally independently designed power supply cells, which are stacked to form at least one cell row and arranged one behind the other. The power supply module interacts with a temperature control device, which is designed to control the temperature of at least a subset of the power supply cells by way of a heating medium. The power supply module furthermore has a clamping device, which is designed to clamp the power supply cells of the at least one cell row, wherein the clamping device has at least two end plates and a tension element for this purpose, wherein the at least two end plates interact with the tension element to form a clamping force acting on the power supply cells.

A power supply module constructed in this way can be contained in a voltage supply apparatus which is arranged in a hybrid vehicle or electric vehicle and by which an electric machine used as a drive motor in such vehicles is supplied with electric power. In a hybrid vehicle, another unit is used for driving in addition to the electric machine, in general an internal combustion engine. In contrast, an electric vehicle is driven exclusively by an electric machine. The electric machines which are used are generally designed as internal rotor machines, in which a rotatably mounted rotor is surrounded by a fixed stator. Synchronous machines, in particular hybrid synchronous machines, can be used as drive motors.

Thus, a power supply module constructed in this way can be used to construct a traction battery installed in a hybrid vehicle or electric vehicle. A traction battery is an electric high-voltage storage device, which can have a voltage level of 250 to 420 volts. To achieve this voltage level, a traction battery is constructed from a large number of power supply cells connected in series, which are preferably of rechargeable design. The power supply cells are generally combined or interconnected to form relatively small groups, referred to as power supply modules, wherein the power supply modules are connected in series to form the traction battery.

During operation of the vehicle, a traction battery and thus the power supply modules or power supply cells installed therein are subject to severe temperature effects or temperature fluctuations. On the one hand, this is due to the heat generated in the power supply cells themselves, arising in said cells due to the provision of electric power. On the other hand, there are external factors acting on a traction battery which affect the temperature of the traction battery, e.g. the seasonal ambient temperature or the location in which the vehicle is being used.

In order, on the one hand, to allow a sufficient range for a hybrid vehicle or electric vehicle, said range depending decisively on the amount of electric power that can be taken from a traction battery, and, on the other hand, to ensure a sufficient life for the traction battery, defined temperature management is required for the traction battery or, in more general terms, for a voltage supply apparatus or the power supply modules or power supply cells installed therein. In particular, it is necessary to cool the voltage supply apparatus or the power supply modules installed therein to enable them to be operated in an optimum temperature range. Depending on the conditions of use, however, it may also be necessary to heat the voltage supply apparatus or the power supply modules installed therein.

For this purpose, the external surfaces of the power supply cells are generally connected to temperature control elements, by means of which the temperature of the power supply cells can be adjusted using a heating medium, which can also be referred to as a heat transfer medium. In particular these are cooling elements, by means of which the power supply cells can be cooled using a fluid, in particular a liquid. However, the fluid can also be a gas or a mixture or blend consisting of at least one gas and at least one liquid. In the case of refrigerants, for example, they may be “two-phase mixtures” consisting of at least one gas and at least one liquid. These temperature control elements or cooling elements can be designed in different ways. For example, they can be embodied as cooling plates with internal fluid channels. As an alternative, these elements can be implemented using an extruded section. As already explained, the power supply cells can be cooled and/or heated. Thus, the heating medium can also be referred to as a temperature control medium. When the term “heating medium” is used below, this is intended to be a synonym for the terms “heat transfer medium” or “temperature control medium”.

Hitherto, the temperature control elements or cooling elements have generally been component parts or components additionally installed in a power supply module, being connected to the power supply cells by pressure and/or adhesive bonding in order to achieve effective temperature control or cooling thereof. In general, such temperature control elements or cooling elements are used simply for temperature control or cooling of the power supply cells. They do not assume or have any other function within the power supply module. The fact that the temperature control elements or cooling elements are independent component parts or components which do not perform any other function within a power supply module apart from temperature control or cooling entails the following disadvantages: on the one hand, additional installation space for these “additional” temperature control elements or cooling elements has to be provided within a power supply module, and therefore there is an increased requirement for installation space. The power supply module could in fact be of smaller construction or embodied in a more compact way. On the other hand, these “additional” temperature control elements or cooling elements involve additional weight, the power supply module being unnecessarily heavy, and could be embodied so as to be of lighter-weight construction.

It is therefore one object of the present invention to provide a power supply module which is of small and lightweight construction and which can be produced easily and at low cost but nevertheless allows reliable temperature control of the power supply cells installed in the power supply module.

This object is achieved by a power supply module of the type stated at the outset in which the tension element is embodied as a functional constituent of the temperature control device and for this purpose has at least one feed connection for feeding heating medium into the tension element and at least one discharge connection for discharging the heating medium which has flowed through at least a partial region of the tension element.

Thus, the power supply module according to the invention is based on the following concept: it was recognized that by combining two functionalities which are required for the operation of a power supply module and which were hitherto distributed between independent component parts or components into a single component part or a single component, there is the possibility of creating a power supply module of compact and lightweight construction. The functionalities to be combined are, on the one hand, the functionality of controlling the temperature of, or cooling, power supply cells and, on the other hand, the functionality of clamping power supply cells. Combining these functionalities is achieved by embodying the tension element as a functional constituent of the temperature control device, more specifically in such a way that the heating medium provided by the temperature control device can flow through it.

By virtue of the fact that the functionalities hitherto distributed between two structurally independent components or component parts, namely the functionality of clamping associated with a tension element, on the one hand, and the functionality of temperature control or cooling associated with a temperature control element or cooling element, on the one hand, are now combined in a single component or in a single component part, it is possible to eliminate or dispense with one component or component part that was installed in the previous power supply modules. This has the effect that the power supply module can, on the one hand, be of smaller construction and, on the other hand, can be lighter in weight. There are thus advantages in respect of the required installation space and of the weight of the power supply module. In particular, it is possible, with the approach according to the invention, to reduce the installation space required in the z direction in the case of power supply modules installed vertically in a vehicle. The elimination of a previously installed component or a previously installed component part furthermore leads to a reduction in the costs of a power supply module, more specifically both as regards the material and as regards production.

Moreover, the following further advantage is obtained: in certain previous power supply modules, there was coupling of the tolerance chains of the cell connectors and the cooling surfaces, namely when the cooling element is mounted at the bottom on the base and the cell connection system at the top on the cover of the power supply module. With the approach according to the invention, this tolerance chain can be eliminated or broken up. In other words: in the case of power supply modules designed in this way, the invention enables decoupling of the tolerance chains of the cell connectors and the cooling surfaces.

The abovementioned object is therefore fully achieved.

Before further details are given of advantageous embodiments of the power supply module according to the invention, consideration will first be given to the integration or combination of the two functionalities of temperature control or cooling of the power supply cells, on the one hand, and clamping of the power supply cells, on the other hand. In the sense according to the invention, it is immaterial how this integration or combination is carried out. In a first approach or first perspective, a tension element can be designed in such a way that, in addition to its original functionality, namely that of clamping, it also performs or has the additional functionality of temperature control or cooling. That is to say that a tension element is designed in such a way that it can simultaneously be used as a cooling element or temperature control element. Accordingly, there is no need to install a temperature control element or cooling element of independent design in a power supply module. In a second approach or a second perspective, a temperature control element or cooling element can be designed in such a way that, in addition to its original functionality, namely that of temperature control or cooling, it also performs or has the additional functionality of clamping. That is to say that a temperature control element or cooling element is designed in such a way that it can simultaneously be used as a tension element. Accordingly, there is no need to install a tension element of independent design in a power supply module. A temperature control element or cooling element designed in this way can simultaneously serve as a tension element. As an alternative, such an element can assist an already existing tension element in its functionality of clamping, wherein the tension element to be assisted can be positioned to the side or above and below the power supply cells. Common to both approaches or perspectives is that: either by virtue of the fact that a tension element has or performs the additional functionality of temperature control or cooling or by virtue of the fact that a temperature control element or cooling element has or performs the additional functionality of clamping, there is a single component part or a single component which performs or combines in itself both the functionality of a tension element and the functionality of a temperature control element or cooling element. Accordingly, it is possible to dispense with one component part or one component in constructing a power supply module. It should once again be stated at this point that both approaches or perspectives should be regarded as entirely equivalent. Owing to the combination of the two functionalities in one component part or in one component, this component part or component can also be referred to as an integrated tension and temperature control element.

In the automotive sector, both power storage cells and energy conversion cells can be used as power supply cells in constructing a traction battery. The power storage cells can be rechargeable lithium-ion storage cells, for example, which are preferably accommodated in a strong metal casing of prismatic design with a wall thickness of 0.3 to 0.5 mm (casings of this kind are also referred to as hard cases) or in a casing made of aluminum composite foil (such casings are also referred to as pouches or soft packs). In the case of lithium-ion storage cells accommodated in this way, there is the need to clamp the power storage cells with a certain force in order to limit “bulging” of these cells and hence to avoid premature aging of the cells. This means that, in the case of power supply modules or, to be more precise, in this case power storage modules, which are constructed by means of the abovementioned lithium-ion storage cells, use is made per se of a clamping device which comprises two end plates and at least one tension element, such a module preferably having two tension elements, which are each designed as tie rods. Accordingly, there is the possibility of integrating the functionality of temperature control or cooling into at least one component of the clamping device. In addition to the abovementioned lithium-ion storage cells, a power supply module according to the invention can also be used in lithium-polymer or lithium-sulfur or lithium-air storage cells or in other power storage cells in which clamping is appropriate. The energy conversion cells can preferably be in the form of fuel cells. Fuel cells are also generally clamped, and therefore integration of the functionality of temperature control or cooling into a clamping device that is correspondingly to be provided or is present is also possible in this case.

By virtue of the fact that the tension element used according to the invention has at least one feed connection for feeding heating medium into the tension element and at least one discharge connection for discharging the heating medium which has flowed through at least a partial region of the tension element, this is a tension element which is actively designed with a view to temperature control or cooling of a power supply module. This is a tension element in which heat transfer is accomplished primarily by means of convection. This is in contrast to tension elements of conventional design, in particular tie rods, where heat transfer is accomplished at most by way of heat conduction or heat radiation and thus passively. It is thus also possible to construct a power supply module in which conventional tension elements, i.e. tension elements of passive design, and tension elements according to the invention, i.e. tension elements of active design, are used simultaneously, wherein the tension elements according to the invention assist the clamping functionality of the conventional tension elements.

The tension element preferably has both a multiplicity of feed connections and a multiplicity of discharge connections. By means of this measure, it is possible, in the case of direct refrigerant cooling for example, to achieve a “winter configuration”, in which the tension element acts as an internal heat exchanger.

The tension element and thus the feed connections and discharge connections thereof are preferably designed to allow a liquid heating medium to flow through or pass through. However, a corresponding embodiment in which gas or a mixture can flow through is also contemplated.

Consistent therewith, the tension element has at least one heating medium channel, which carries the heating medium. This should preferably be a tension element which is constructed from sheet-like or continuous tension element components, within which the at least one heating medium channel is located. If lithium-ion storage cells accommodated in a strong metal casing of prismatic design are involved, for example, these power supply cells, to be precise the power storage cells, have a height which corresponds to the distance between the base of the cell and the cell cover having the connections. The tension element and thus the tension element components thereof should now have a width matched to this height, wherein the tension element components should be of sheet-like or continuous design over this width. The tension element components are preferably designed as “hollow-chamber profiles”, which have at least one chamber extending in a longitudinal direction, wherein this chamber is the heating medium channel. The tension element should preferably be designed in such a way that it encloses three sides of a cell row, preferably the two longitudinal sides and one of the two transverse sides. Accordingly, the heating medium channel is designed in such a way that it encloses at least part of the periphery of the cell row, namely along the two longitudinal sides and one transverse side.

In an alternative embodiment, the tension element has a plurality of heating medium channels which are of structurally independent design and are connected fluidically for parallel or countercurrent flow. In this embodiment, the individual tension element components are not of sheet-like or continuous design over the width described above. On the contrary, the tension element is composed of a plurality of sections of structurally independent design, wherein each of the sections can be designed as a hollow chamber profile. In respect of through flow of the heating medium, the individual sections should here be connected fluidically for parallel or countercurrent flow.

By using hollow chamber profiles to construct the tension element, a simple and low-cost construction of the power supply module is possible, on the one hand, and, on the other hand, reliable temperature control of the power supply cells is ensured.

In a preferred embodiment of the invention, the tension element is constructed from at least one transverse element and at least two longitudinal elements, each having an end adjacent to the transverse element and a free end, wherein the at least one feed connection and the at least one discharge connection are associated spatially with the free ends. This measure allows reliable temperature control of the power supply cells since the standardized attachment or orientation of the connections makes the interconnection of the individual tension elements with other components belonging to the temperature control device simple and inexpensive. Provision can preferably be made for one longitudinal element to have both connections. Alternatively, provision can be made for the at least one feed connection to be associated with the free end of one longitudinal element and for the at least one discharge connection to be associated with the free end of the other longitudinal element. This results in greater flexibility in the interconnection of the individual tension elements with other components belonging to the temperature control device.

In a preferred embodiment of the invention, at least one of the two longitudinal elements has a connection element arranged at the free end thereof, wherein the connection element has the at least one feed connection and/or the at least one discharge connection. On the one hand, this measure contributes to a simple construction of the tension element and thus of the power supply module. On the other hand, this measure allows reliable temperature control of the power supply cells. Both the connection element and the longitudinal elements can be designed and then also produced specifically with a view to the respective requirements. Thus it is ensured, for example, that the most suitable construction for meeting the respective requirement can be chosen in each case. In corresponding fashion, optimization in terms of production technology can also be performed, allowing low-cost production of the tension element and thus of the power supply module. It is preferable if both longitudinal elements have a connection element, wherein one longitudinal element then has the feed connection and the other longitudinal element the discharge connection. This measure allows greater flexibility in the interconnection of the individual tension elements with other components belonging to the temperature control device.

In another advantageous embodiment of the abovementioned measure, the connection element is of cylindrical design with a connection element bottom, a connection element top and a connection element shell, wherein the at least one feed connection and/or the at least one discharge connection is situated in the connection element bottom or the connection element shell or the connection element top. The cylindrical connection element preferably has a circular base surface, giving multiple attachment possibilities or alignments for the feed connection and the discharge connection, this being the case especially when the feed connection and/or the discharge connection is/are arranged on the connection element shell. The feed connection and/or the discharge connection is/are preferably arranged on the connection element shell in such a way that the respective connection points in the direction of the longitudinal axis of the cell row. In this case, the connections can be “served” from one direction, i.e. can be connected or fitted with coupling elements, e.g. lines, via which the individual tension elements can then be interconnected to other components belonging to the temperature control device. The alternative arrangement of the feed connection and/or discharge connection in the connection element bottom or the connection element top allows a very compact construction of the voltage supply apparatus since it is thereby possible, for example, to stack the power supply modules one on top of the other within the voltage supply apparatus.

By virtue of the fact that the tension element is constructed from at least one transverse element and at least two longitudinal elements, each having an end adjacent to the transverse element and a free end, each of the cell rows logically has a power supply cell adjacent to the transverse element and a free power supply cell, wherein one of the two end plates rests as an end plate adjacent to the transverse element against the power supply cell adjacent to the transverse element and the other end plate rests as a free end plate against the free power supply cell. The end plate adjacent to the transverse element is advantageously designed to compensate for length tolerances occurring in the cell row. By means of this measure, production-related differences in length in the power supply cells can be compensated, thereby ensuring reliable clamping and thus also temperature control of the cells. The end plate adjacent to the transverse element is preferably designed in such a way, e.g. by incorporating elastic elements, that to a certain extent it has a spring action. In another perspective, the cell row has a power supply cell on the first side and a power supply cell on the last side, wherein one of the two end plates rests as an end plate on the first side against the power supply cell on the first side and the other end plate rests as an end plate on the last side against the power supply cell on the last side. In this case, the end plate on the last side should be designed to compensate length tolerances occurring in the cell row.

In an advantageous embodiment of the invention, the power supply cells are arranged to form a single cell row or a multiplicity of cell rows situated in one plane and arranged adjacent to one another, wherein the tension element is constructed from a transverse element and two longitudinal elements, each having an end adjacent to the transverse element and a free end, wherein the transverse element and the two longitudinal elements form a tension element, which encloses one of the two end plates. By virtue of this arrangement of the transverse element and the two longitudinal elements, this is a tension element of u-shaped configuration which surrounds the end plate adjacent to the transverse element or end plate on the last side. This tension element is simple to produce and simple to handle when assembling the power supply module, the overall effect being that the power supply module can, on the one hand, be produced at low cost and, on the other hand, allows reliable temperature control of the power supply cells. The tension element of u-shaped configuration is distinguished by a minimum number of joints.

If the power supply cells are arranged to form a plurality of cell rows situated in one plane and arranged adjacent to one another, then, in another advantageous embodiment of the invention, the tension element can be constructed from at least two transverse elements, two longitudinal elements, each having an end adjacent to the transverse element and a free end, and at least one further longitudinal element having two ends adjacent to the transverse element, wherein the transverse elements, the longitudinal elements and the at least one further longitudinal element form a meandering tension element. A tension element embodied in this way is passed in a meandering shape through the cell rows. In comparison with the tension element described above, a tension element constructed in this way is admittedly not as economical to produce, but it allows improved temperature control of the power supply cells.

In a particularly preferred embodiment of the abovementioned measure, the further longitudinal element is designed likewise to allow the heating medium to flow through. With the aid of these further longitudinal elements, which are of active design in terms of heat transfer, the power supply cells can be temperature-controlled in the best possible way. Instead of a further longitudinal element of active design, it is also possible to use further longitudinal elements of passive design, i.e. further longitudinal elements of the kind which are known from conventional tie rods, i.e. tie rods of passive design. If further longitudinal elements of passive design are used, a different arrangement of the feed connections and discharge connections is required, e.g. they can be attached to one of the transverse elements.

In another preferred embodiment of the invention, the longitudinal elements rest laterally by their free ends against the respectively associated end plates. In a first embodiment, the longitudinal elements and the end plate can be connected nonpositively to one another, thereby enabling the power supply module to be produced at particularly low cost. The nonpositive connection can be achieved, for example, through appropriate dimensioning or shaping of the longitudinal elements to bring about a prestress. As an alternative, the longitudinal elements and the end plates can be connected to one another materially, e.g. by means of welding or adhesive bonding, or positively, by means of riveting or clinching.

In an advantageous embodiment of the invention, the tension element rests via a heat conduction component against the power supply cells. By means of this measure, optimum heat transfer between the power supply cells and the tension element and thus optimum temperature control of the power supply cells is ensured. A heat conducting foil, a thermally conductive adhesive or a “phase change material”, for example, can be used as a heat conducting component. A phase change material is distinguished by the fact that the heat of fusion or heat of solution or heat of absorption is significantly greater than the heat which it can store on the basis of its normal specific heat capacity, i.e. without the phase change effect.

Using a power supply module according to the invention, it is possible to construct a voltage supply apparatus which is designed to supply a supply voltage in a vehicle. In the power supply module according to the invention, a tension element designed in accordance with the invention is used, that is to say a tension element which is of active design in terms of heat transfer.

As already explained, the temperature control of the power supply cells in the power supply module according to the invention is accomplished by way of a heating medium. The heating medium can be a coolant or a refrigerant.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows, with the aid of a schematic illustration, the basic structure of a voltage supply device, arranged in a vehicle, in which power supply modules according to the invention are installed.

FIG. 2 shows the basic structure of a power supply module with the aid of a schematic illustration.

FIG. 3 shows a first embodiment of a power supply module with the aid of a schematic illustration.

FIGS. 4A and 4B show two different embodiments of a connection element with the aid of two subfigures.

FIG. 5 shows a second embodiment of a power supply module with the aid of a schematic illustration.

FIGS. 6A and 6B show a third embodiment of a power supply module by means of a schematic illustration with the aid of two subfigures.

FIGS. 7A and 7B show a fourth embodiment of a power supply module by means of a schematic illustration with the aid of two subfigures.

FIG. 8 shows a fifth embodiment of a power supply module with the aid of a schematic illustration.

FIG. 9 shows a sixth embodiment of a power supply module with the aid of a schematic illustration.

FIG. 10 shows a seventh embodiment of a power supply module with the aid of a schematic illustration.

FIG. 11 shows an eighth embodiment of a power supply module with the aid of a schematic illustration.

### DETAILED DESCRIPTION OF THE DRAWINGS

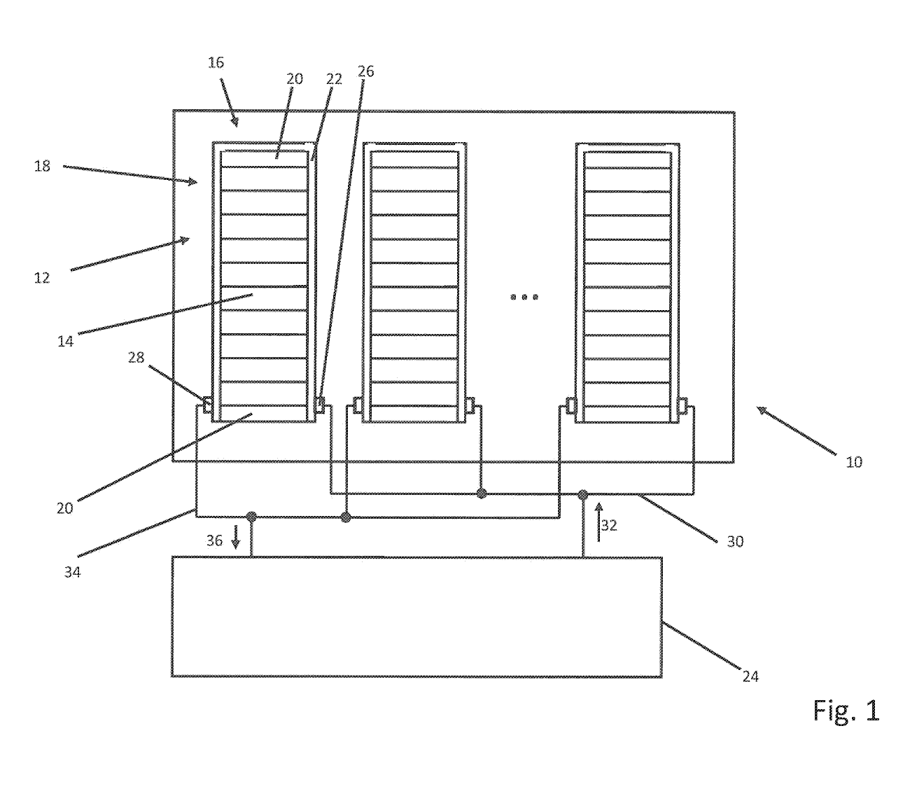

FIG. 1 shows a voltage supply device 10, which is arranged in a vehicle (not shown). The voltage supply device 10 contains a plurality of power supply modules, of which one is indicated by the reference sign 12 by way of example. Each of these power supply modules 12 is constructed from a plurality of structurally independently designed power supply cells, of which one is indicated by the reference sign 14 by way of example. The power supply cells 14 can be power storage cells or energy conversion cells. They are preferably power storage cells which are designed as rechargeable lithium-ion storage cells. For each of the power supply modules, the power supply cells are arranged to form at least one cell row 16. The illustration chosen in FIG. 1, according to which all the power supply modules are embodied as a single row, is not intended to have any restrictive effect. The power supply modules can, of course, also be of multi-row construction. It is also contemplated for power supply modules of single-row and multi-row construction to be used simultaneously in a voltage supply device.

Each of the power supply modules 12 has a clamping device 18, which is designed to clamp the respective power supply cells 14. For this purpose, the clamping device 18 has at least two end plates 20 and a tension element 22. The two end plates 20 and the tension element 22 interact to form a clamping force acting on the power supply cells 14.

The power supply modules 12 each interact with a temperature control device 24, which is designed to control the temperature of at least a subset of the power supply cells 14 by use of a heating medium. It is envisaged here that the tension element 22 is designed as a functional constituent of the temperature control device 24. For this purpose, the tension element 22 has at least one feed connection 26 for feeding heating medium into the tension element 22 and at least one discharge connection 28 for discharging the heating medium that has flowed through at least a partial region of the tension element 22. The feed connection 26 is connected to the temperature control device 24 by a first line 30, wherein heating medium is fed to the tension element 22 from the temperature control device 24 via the first line 30, this being indicated by an arrow 32. The discharge connection 28 is connected to the temperature control device 24 by a second line 34, wherein heating medium is fed from the tension element 22 to the temperature control device 24 via the second line 34, this being indicated by an arrow 36. The tension element 22 has at least one heating medium channel (not visible in FIG. 1) carrying the heating medium.

FIG. 1 shows a number of power supply cells, from which a power supply module is constructed. This number to be seen in FIG. 1 is not intended to have a restrictive effect. It is, of course, also possible for a power supply module to have a different number of power supply cells. No further details of the specific construction of the temperature control device 24 will be given in the context of this invention. It is self-evident that the temperature control device 24 contains the components required to be able to control the temperature of power supply cells with the aid of a refrigerant or a coolant.

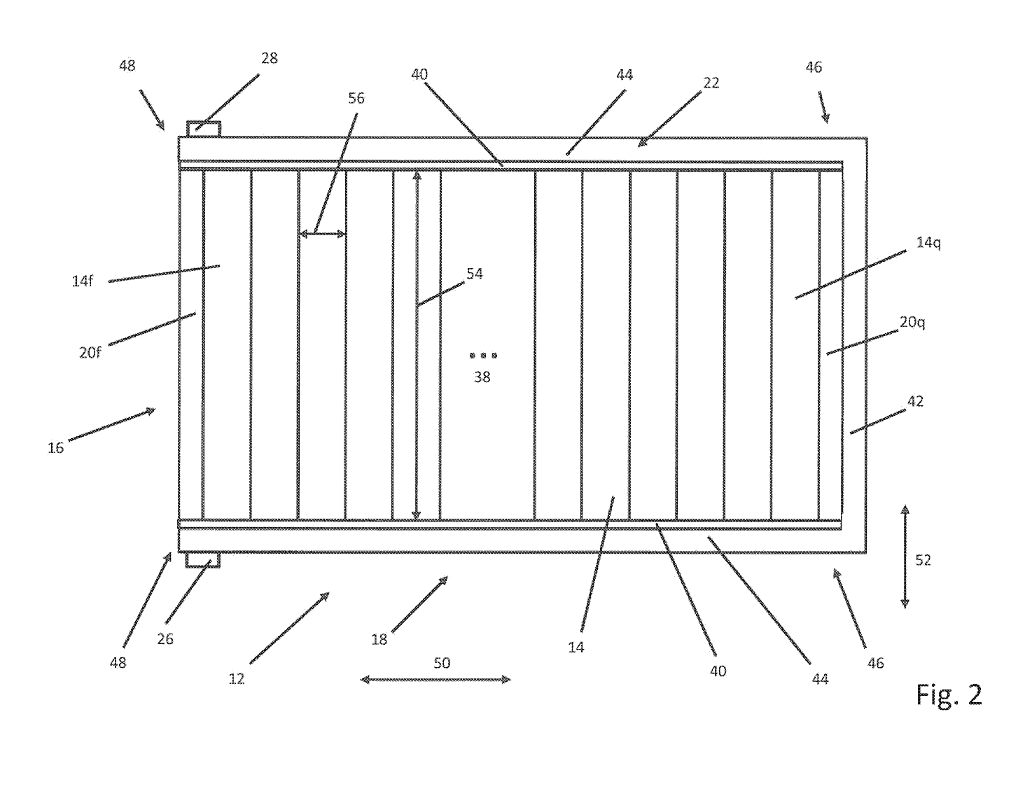

FIG. 2 shows a power supply module 12 which is constructed from a plurality of structurally independently embodied power supply cells 14. The power supply cells 14 are arranged to form a cell row 16. Dots 38 are used to indicate that the power supply module 12 can be constructed from any desired number of power supply cells. The power supply cells 14 are arranged between two end plates 20f, 20q, which interact with a tension element 22 to form a clamping force acting on the power supply cells 14. As can be seen from the illustration in FIG. 2, the tension element 22 rests on the power supply cells 14 via a heat conducting component 40. The heat conducting component 40 can be designed as a heat conducting foil, as a thermally conductive adhesive or as a “phase change material”. By means of the heat conducting component 40, optimum heat transfer from the power supply cells 14 to the tension element 22 is ensured.

As can furthermore be seen from the illustration in FIG. 2, the tension element 22 is constructed from at least one transverse element 42 and at least two longitudinal elements 44, each having an end 46 adjacent to the transverse element and a free end 48. As can furthermore be seen from the illustration, the feed connection 26 and the discharge connection 28 are associated spatially with the free ends 48.

The cell row 16 has a power supply cell 14q adjacent to the transverse element and a free power supply cell 14f, wherein one of the two end plates rests as an end plate 20q adjacent to the transverse element against the power supply cell 14q, and the other end plate rests as a free end plate 20f against the free power supply cell 14f In an advantageous embodiment, the end plate 14q adjacent to the transverse element should be designed to compensate length tolerances occurring in the cell row 16.

As can be seen from the illustration in FIG. 2, the power supply module 12 or cell row 16 has a longitudinal axis 50 and a transverse axis 52. The power supply cells 14 have a length 54, a width 56 and a height 58, which is not shown in FIG. 2 because it is outside the plane of the drawing.

The arrangement of the feed connection 26 and of the discharge connection 28 on the tension element 22 as shown in FIGS. 1 and 2 is not intended to have a restrictive effect. The arrangement of these two connections is explained thoroughly in conjunction with the figures that remain to be described below.

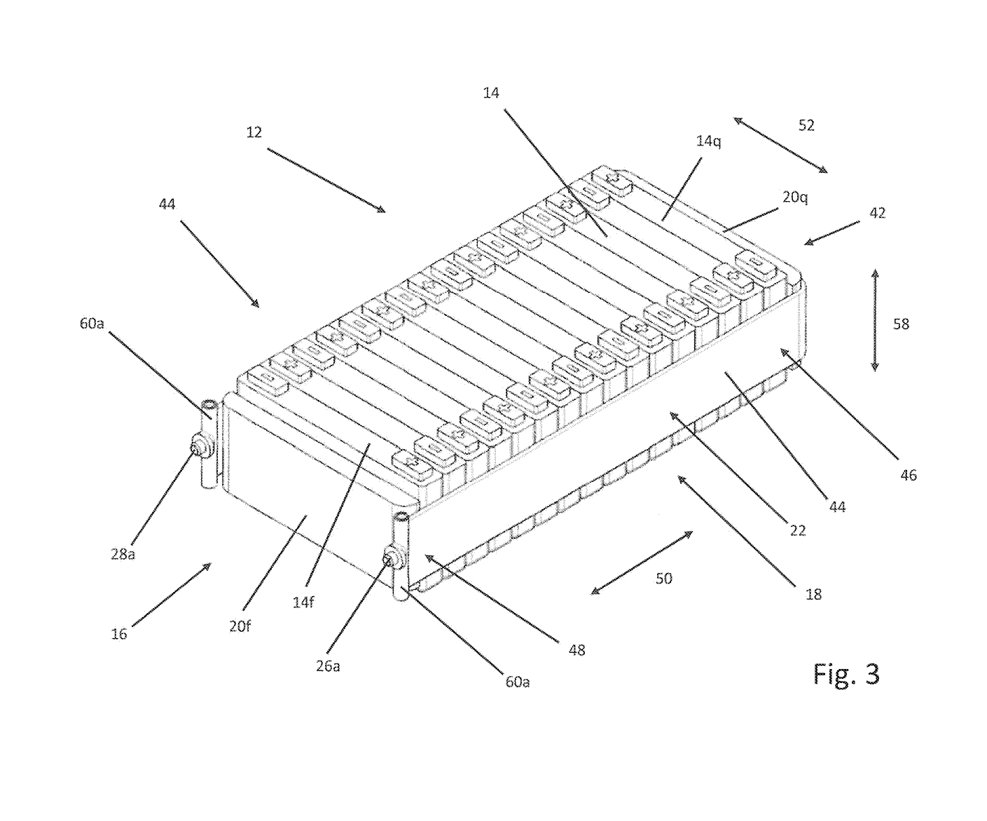

FIG. 3 shows a first embodiment of a power supply module 12. In this embodiment, the power supply cells 14 are arranged to form a single cell row 16, wherein the tension element 22 is constructed from a transverse element 42 and two longitudinal elements 44, each having an end 46 adjacent to the transverse element and a free end 48. The transverse element 42 and the two longitudinal elements 44 form a tension element 22, which encloses the end plate 20q. At least one heating medium channel (not shown), which carries the heating medium, is formed in the tension element. The two longitudinal elements 44 rest laterally by way of their free ends 48 against the end plate 20f The longitudinal elements 44 and the end plate 20f can be connected nonpositively or materially or positively to one another.

As can be seen from the illustration in FIG. 3, the two longitudinal elements 44 each have a connection element 60a on their free ends 48, wherein one of these two connection elements 60a has the feed connection 26 and the other connection element 60a has the discharge connection 28. This allocation is not intended to have a restrictive effect. In a correspondingly modified way, the two connections can be located on one of the two connection elements. It is also contemplated for just one longitudinal element to have a connection element with both connections. In a corresponding way, these embodiments are also intended to apply to figures that remain to be described, insofar as applicable.

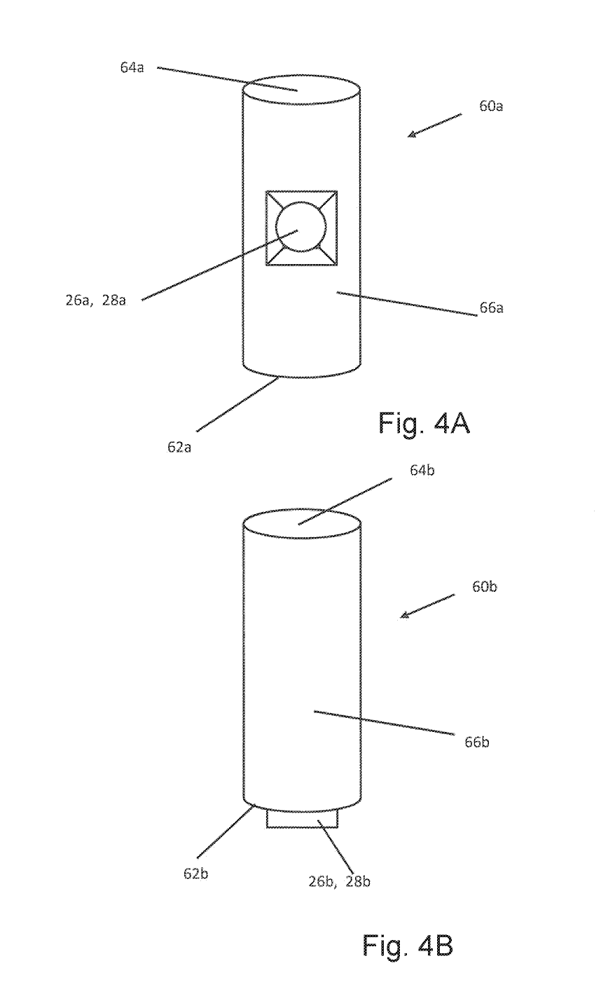

FIG. 4 comprises two subfigures 4A and 4B, each showing a connection element of cylindrical design with a circular base surface. Both connection elements 60a, 60b have a connection element bottom 62a, 62b, a connection element top 64a, 64b and a connection element shell 66a, 66b. In the case of the connection element 60a shown in subfigure 4A, the feed connection 26a or the discharge connection 28a is arranged in the connection element shell 66a. In this type of arrangement, provision can be made, in the installed state, for the respective connection 26a, 28a to point in the direction of the longitudinal axis 50 of the cell row 16. Subfigure 4B shows an alternative type of arrangement, in which the feed connection 26b or the discharge connection 28b is arranged in the connection element bottom 62b. In another alternative type of arrangement, the two connections 26b, 28b can also be arranged in the connection element top 64b.

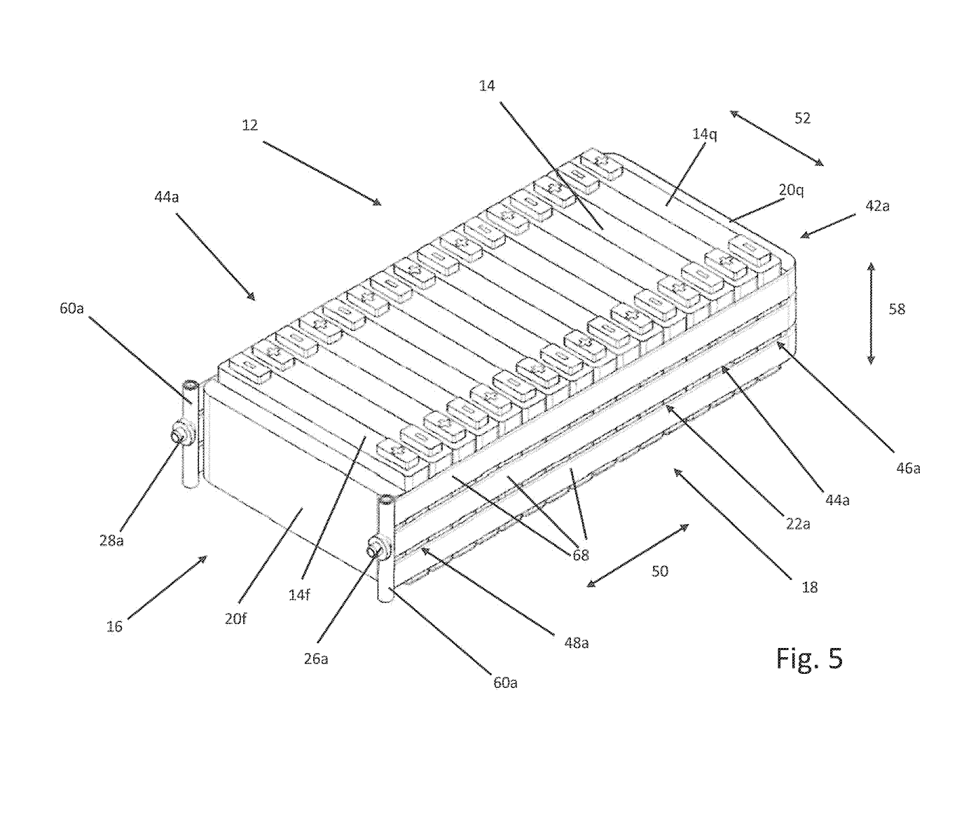

FIG. 5 shows a second embodiment of a power supply module 12. In this embodiment too, the power supply cells 14 are arranged to form a single cell row 16. Here too, the tension element 22a is constructed from a transverse element 42a and two longitudinal elements 44a, each having an end 46a adjacent to the transverse element and a free end 48a. The transverse element 42a and the two longitudinal elements 44a form a tension element 22a, which surrounds the end plate 20q. In this embodiment, both the transverse element 42a and the two longitudinal elements 44a are constructed from a multiplicity of heating medium channels 68, in the present case from three heating medium channels, which are structurally independently formed and connected fluidically for parallel or countercurrent flow. Accordingly, the tension element 22a has a plurality of structurally independently formed heating medium channels 68 connected fluidically for parallel or countercurrent flow. Here too, the two longitudinal elements 44a rest laterally by means of their free ends 48a against the end plate 20f The longitudinal elements 44a and the end plate 20f can be connected to one another nonpositively or materially or positively. According to FIG. 3, the two longitudinal elements 44a each have a connection element 60a at their free ends 48a, wherein one of these two connection elements has the feed connection 26a and the other connection element 60 has the discharge connection 28a.

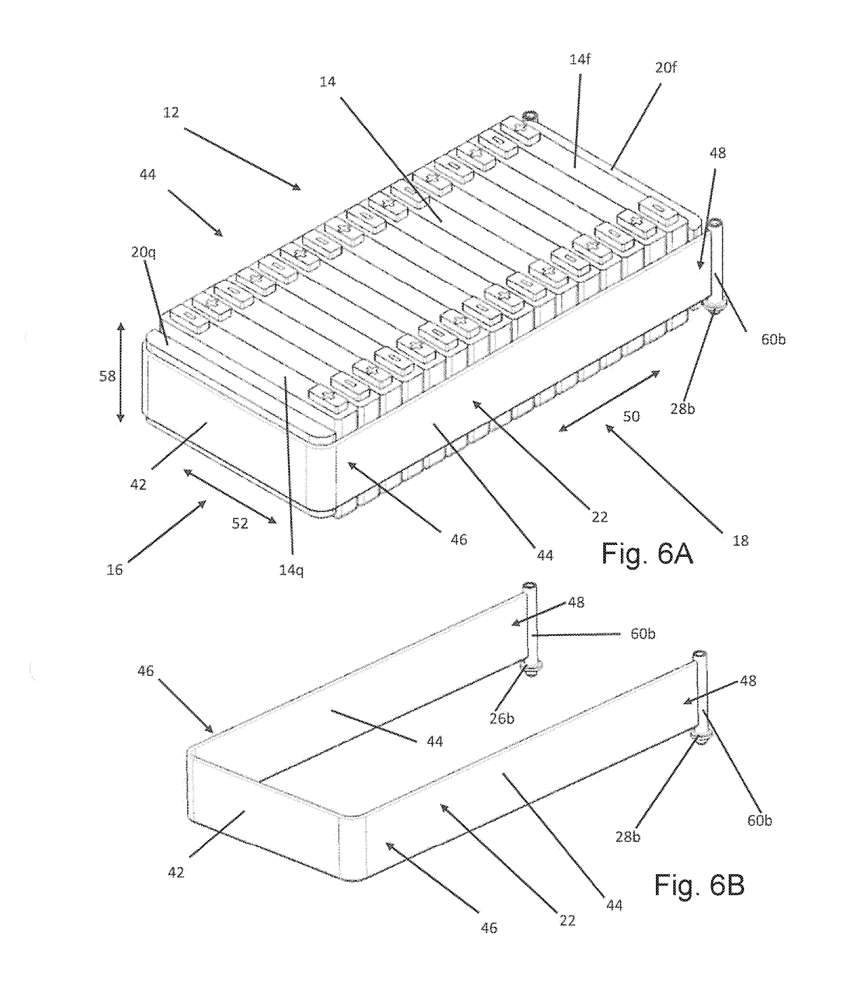

FIG. 6 shows a third embodiment of a power supply module 12 with the aid of two subfigures. The power supply module shown in the two subfigures 6A, 6B corresponds in its basic construction to the power supply module shown in FIG. 3, for which reason the statements made in connection with FIG. 3 are also intended to apply to the power supply module shown in subfigures 6A, 6B. The two power supply modules differ in that the power supply module 12 shown in subfigures 6A, 6B has connection elements 60b, on which the feed connection 26b and the discharge connection 28b are arranged in the connection element bottom.

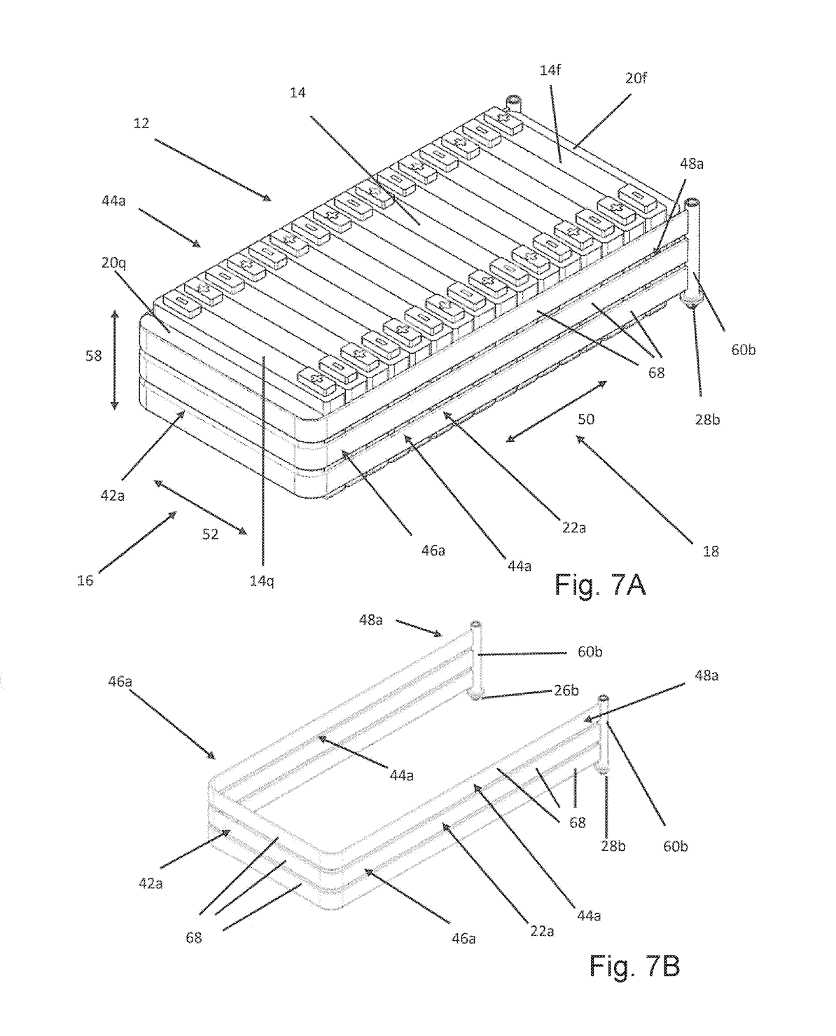

FIG. 7 shows a fourth embodiment of a power supply module 12 with the aid of two subfigures. The power supply module shown in the two subfigures 7A, 7B corresponds in its basic construction to the power supply module shown in FIG. 5, for which reason the statements made in connection with FIG. 5 are also intended to apply to the power supply module shown in subfigures 7A, 7B. The two power supply modules differ in that the power supply module 12 shown in subfigures 7A, 7B has connection elements 60b, on which the feed connection 26b and the discharge connection 28b are arranged in the connection element bottom.

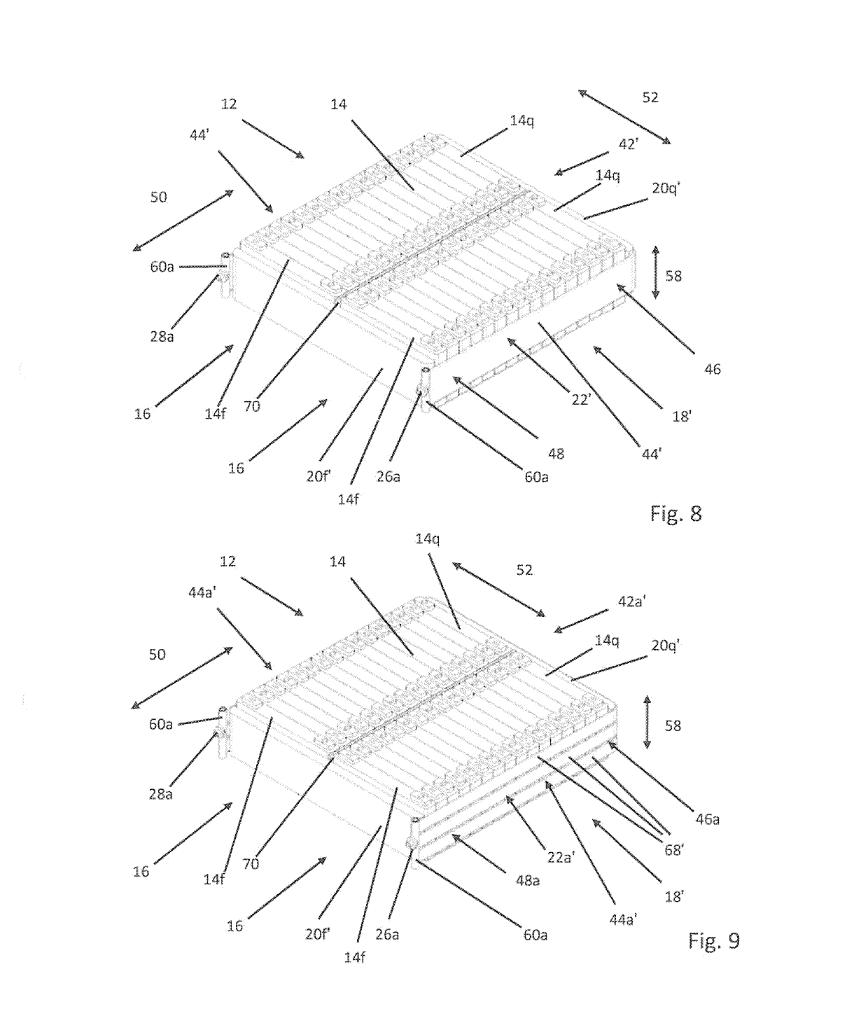

FIGS. 3, 5, 6 and 7 show power supply modules, in each of which the power supply cells are arranged to form a single cell row. In contrast, the power supply cells in FIGS. 8 and 9, which will be described below, are arranged to form a plurality, to be specific to form two, cell rows situated in one plane and arranged adjacent to one another. Both in the case of the individual cell row and in the case of the cell rows arranged adjacent to one another, the tension element for the power supply modules shown in the abovementioned figures is constructed from a transverse element and two longitudinal elements, each having an end adjacent to the transverse element and a free end, wherein the transverse element and the two longitudinal elements form a tension element which surrounds at least one end plate.

FIG. 8 shows a fifth embodiment of a power supply module 12. In this embodiment, the power supply cells 14 are arranged to form two cell rows 16, wherein the tension element 22′ is constructed from a transverse element 42′ and two longitudinal elements 44′, each having an end 46 adjacent to the transverse element and a free end 48. The transverse element 42′ and the two longitudinal elements 44′ form a tension element 22′, which surrounds the end plate 20q′. At least one heating medium channel (not shown) carrying the heating medium is formed in the tension element 22′. The two longitudinal elements 44′ rest laterally by means of their free ends 48 against the end plate 20f. The longitudinal elements 44′ and the end plate 20f can be connected to one another nonpositively or materially or positively. Arranged between the two cell rows 16 is a heat conducting plate 70, by which it is possible to conduct heat from those sides of the power supply cells which face the interspace between the two cell rows 16 to the two end plates 20f, 20q′.

As can be seen from the illustration in FIG. 8, the two longitudinal elements 44′ each have a connection element 60a at their free ends 48, wherein one of these two connection elements 60a has the feed connection 26a and the other connection element 60a has the discharge connection 28a. The statements made in connection with FIG. 3 are intended to apply in a corresponding way.

FIG. 9 shows a sixth embodiment of a power supply module 12. In this embodiment too, the power supply cells 14 are arranged in two cell rows 16. Here too, the tension element 22a′ is constructed from a transverse element 42a′ and two longitudinal elements 44a′, each having an end 46a adjacent to the transverse element and a free end 48a. The transverse element 42a′ and the two longitudinal elements 44a′ form a tension element 22a′, which surrounds the end plate 20q′. In this embodiment, both the transverse element 42a′ and the two longitudinal elements 44a′ are constructed from a plurality of heating medium channels 68′, in the present case from three heating medium channels, which are structurally independently formed and/or connected fluidically for parallel or countercurrent flow. Accordingly, the tension element 22a′ has a plurality of structurally independently formed heating medium channels 68′ connected fluidically for parallel or countercurrent flow. Here too, the two longitudinal elements 44a′ rest laterally by means of their free ends 48a against the end plate 20f. The longitudinal elements 44a′ and the end plate 20f can be connected to one another nonpositively or materially or positively. According to FIG. 8, the two longitudinal elements 44a′ each have a connection element 60a at their free ends 48a, wherein one of these two connection elements 60a has the feed connection 26a and the other connection element 60a has the discharge connection 28a. Here too, a heat conducting plate 70 is arranged between the two cell rows 16.

In the two embodiments shown in FIGS. 8 and 9, the free end plate 20f is embodied in such a way that it rests against two free power supply cells 14f, and the end plate 20q′ adjacent to the transverse element is embodied in such a way that it rests against two power supply cells 14q adjacent to the transverse element. According to the illustration in FIGS. 8 and 9, the heat conducting plate 70 is a component of passive design in terms of heat transfer. As an alternative, the use of a component of active design is contemplated.

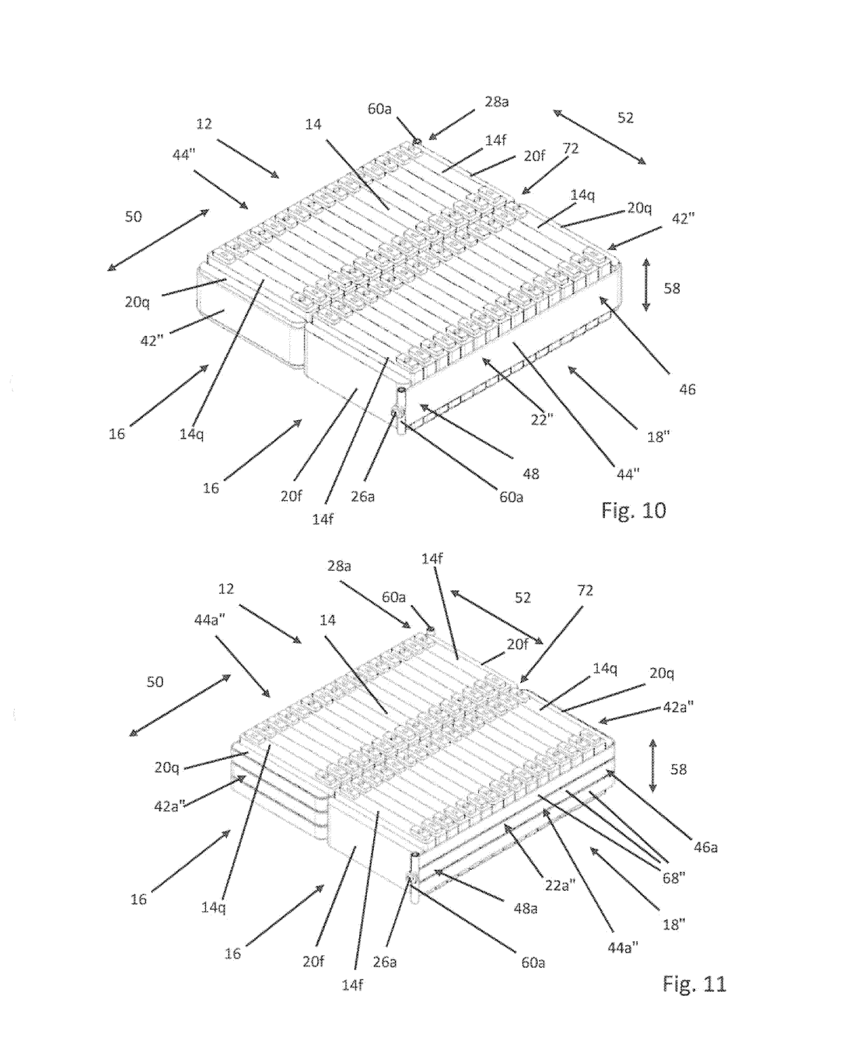

In the two figures that remain to be described, FIGS. 10 and 11, the power supply cells 14 are likewise arranged to form a plurality of cell rows 16, to be specific two cell rows 16 situated in one plane and arranged adjacent to one another. In these two embodiments, however, the tension element 22 is of meandering design.

In the power supply module 12 shown in FIG. 10 and constructed in accordance with a seventh embodiment, the tension element 22″ is constructed from two transverse elements 42″, two longitudinal elements 44″, each having an end 46 adjacent to the transverse element and a free end 48, and a further longitudinal element 72 (difficult to see because of the perspective representation), having two ends (difficult to see because of the perspective representation) adjacent to the transverse element. The further longitudinal element 72 can advantageously be designed likewise to allow the heating medium to flow through, i.e. it can be a component of active design in terms of heat transfer. As an alternative, it is also conceivable to make the further longitudinal element passive.

FIG. 11 shows a power supply module constructed in accordance with an eighth embodiment, the basic construction of which corresponds to the power supply module shown in FIG. 10, for which reason the statements made in connection with FIG. 10 are also intended to apply to the power supply module shown in FIG. 11. The two energy supply modules differ in that, in the power supply module 12 shown in FIG. 11, both the transverse elements 42a″ and the two longitudinal elements 44a″ are constructed from a plurality of heating medium channels 68″, in the present case from three heating medium channels, which are structurally independently formed and are connected fluidically for parallel or countercurrent flow. Accordingly, the tension element 22a″ has a plurality of structurally independently formed heating medium channels 68″ connected fluidically for parallel or countercurrent flow.

The illustration chosen in FIGS. 8, 9, 10 and 11, according to which use is made, on the power supply modules shown in these figures, of connection elements 60a on which both the feed connection 26a and the discharge connection 28a are arranged in the connection element shell, are not intended to have a restrictive effect. Of course, it is also possible to use connection elements on which these connections are arranged in the connection element bottom and/or in the connection element top. The illustration chosen in FIGS. 8, 9, 10 and 11, according to which two cell rows are arranged adjacent to one another, is furthermore not intended to have a restrictive effect. Of course, it is also possible for more than two cell rows to be arranged adjacent to one another.

### LIST OF REFERENCE SIGNS

10 voltage supply device
12 power supply module
14 power supply cell
16 cell row
18 clamping device
20 end plates
22 tension element
24 temperature control device
26 feed connection
28 discharge connection
30 first line
32 arrow
34 second line
36 arrow
38 dots
40 heat conducting component
42 transverse element
44 longitudinal element
46 end adjacent to the transverse element
48 free end
50 longitudinal axis
52 transverse axis
54 length
56 width
58 height
60 connection element
62 connection element bottom
64 connection element top
66 connection element shell
68 heating medium channel
70 heat conducting plate
72 further longitudinal element

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A power supply module for a voltage supply apparatus arranged in a vehicle, comprising:
a plurality of structurally independently designed power supply cells, wherein the plurality of power supply cells are stacked to form at least one cell row and arranged one behind the other;
a temperature control device, wherein the temperature control device is designed to control a temperature of at least a subset of the power supply cells by way of a heating medium;
a clamping device, which is designed to clamp the power supply cells of the at least one cell row, wherein
the clamping device has at least two end plates and a tension element,
the at least two end plates interact with the tension element to form a clamping force acting on the power supply cells,
the tension element is designed as a functional constituent of the temperature control device and has at least one feed connection for feeding the heating medium into the tension element and at least one discharge connection for discharging the heating medium which has flowed through at least a partial region of the tension element.

2. The power supply module as claimed in claim 1, wherein
the tension element has at least one heating medium channel, which carries the heating medium.

3. The power supply module as claimed in claim 1, wherein
the tension element has a plurality of heating medium channels, which are of structurally independent design and are connected fluidically for parallel or countercurrent flow.

4. The power supply module as claimed in claim 1, wherein
the tension element is constructed from at least one transverse element and at least two longitudinal elements, each having an end adjacent to the transverse element and a free end,
the at least one feed connection and the at least one discharge connection are associated spatially with the free ends.

5. The power supply module as claimed in claim 4, wherein
the at least one feed connection is associated with the free end of one longitudinal element and the at least one discharge connection is associated with the free end of the other longitudinal element.

6. The power supply module as claimed in claim 5, wherein
at least one of the two longitudinal elements has a connection element arranged at the free end thereof,
the connection element has the at least one feed connection and/or the at least one discharge connection.

7. The power supply module as claimed in claim 4, wherein
at least one of the two longitudinal elements has a connection element arranged at the free end thereof,
the connection element has the at least one feed connection and/or the at least one discharge connection.

8. The power supply module as claimed in claim 6, wherein
the connection element is of cylindrical design with a connection element bottom, a connection element top and a connection element shell,
the at least one feed connection and/or the at least one discharge connection is situated in the connection element bottom or the connection element shell or the connection element top.

9. The power supply module as claimed in claim 4, wherein
each of the cell rows has a power supply cell adjacent to the transverse element, and a free power supply cell,
one of the two end plates rests as an end plate adjacent to the transverse element against the power supply cell adjacent to the transverse element, and
the other end plate rests as a free end plate against the free power supply cell,
the end plate adjacent to the transverse element is designed to compensate for length tolerances occurring in the cell row.

10. The power supply module as claimed in claim 4, wherein
the transverse element and the two longitudinal elements form a tension element, which encloses one of the two end plates.

11. The power supply module as claimed in claim 4, wherein
the power supply cells are arranged to form the plurality of cell rows situated in one plane and arranged adjacent to one another,
the tension element is constructed from at least two transverse elements, two longitudinal elements, each of the two longitudinal elements having an end adjacent to the transverse element and a free end, and at least one further longitudinal element having two ends adjacent to the transverse element,
the two transverse elements, the two longitudinal elements and the at least one further longitudinal element form a meandering tension element.

12. The power supply module as claimed in claim 11, wherein the further longitudinal element is likewise designed to allow the heating medium to flow through.

13. The power supply module as claimed in claim 10, wherein the two longitudinal elements rest laterally by their free ends against the respectively associated end plates.

14. The power supply module as claimed in claim 1, wherein the tension element rests via a heat conduction component against the power supply cells.

15. A voltage supply apparatus which is designed to supply a supply voltage in a vehicle, comprising a power supply module as claimed in claim 1.

16. A tension element which is designed to be used in a power supply module as claimed in claim 1.
